(19) United States
(12) Patent Application Publication
(10) Pub. No.: US 2008/0161985 A1
(43) Pub. Date: Jul. 3, 2008

(54) Adjusting of the fuel consumption of a water vessel

(76) Inventor: Stefan Hallstensson, Ostervik (SE)

Correspondence Address: DENNISON, SCHULTZ & MACDONALD, 1727 KING STREET, SUITE 105, ALEXANDRIA, VA, 22314, US

(21) Appl. No.: 11/948,186

(22) Filed: Nov. 30, 2007

Related U.S. Application Data
(63) Continuation-in-part of application No. 10/012,359, filed on Dec. 12, 2001, now abandoned.

(30) Foreign Application Priority Data
Feb. 26, 2001 (SE) 0100666-7

(51) Int. Cl. G06F 17/00

(52) U.S. Cl. 701/21

(57) ABSTRACT

Fast boats create a water resistance that has a great effect on the consumption of fuel. The object of the present invention is to reduce the water resistance to a minimum by means of an arrangement that semi-automatically adjusts the direction of the propulsion force and the trimming planes so that minimum water resistance is obtained.

### CROSS REFERENCE TO RELATED APPLICATIONS

This is a Continuation-in-Part of application Ser. No. 10/012,359, filed Dec. 12, 2001, the contents of which is incorporated herein by reference.

### BACKGROUND OF THE INVENTION

The present invention is related to a control and trimming system for a water vessel with stern propulsion. The water vessel has a stern propulsion or similar which can be jet with water or similar. When the vessel moves forward, the body force the water and the energy which is needed for this is coming from the engine. The water resistance force is an important parameter and the higher this is the higher the fuel consumption will be. In most cases it is important to reduce the consumption to the lowest level possibly, at the same time giving the vessel a smooth behaviour in the water.

It is also preferred that the vessel lies horizontal in the water as to increase the sight forward.

There exist a lot of theories and different designs of the body of a ship. Most common is a body with a shaped front.

Water vessels can be designed to reduce the water-move-away force by a design which decreases the depth in the water of the body. The target is to “lift up the body” above the water surface. The technique is called “planar”, and to get this there is a need for high power. But when the vessel come to this status, suddenly the amount of water which is pushed away decreases and the result is a much lower fuel consumption.

There is a new technique where the design is in such that an air pillow is built up between the water surface and the body of the vessel.

There are a lot of techniques to force the vessel to the “planar” stage and the most well-known is using trimming bodies. It is well-known that at high changing of the throttle the result is that the stern is pushed down. With trim-bodies this effect can be reduced. But the angel of the trim-bodies must be trimmed in correlation to the speed. That means that to reach an optimum of low fuel consumption the trimming must be done continuously. The driver of the water vessel will be fully busy with this trimming.

It is quite common that a water vessel driver is fully occupied with doing other things as navigate, controlling the speed and having control of people on board. Even for a person used to drive there is a lot of things to have control of, and for a new beginner it is too much.

It is also common that there is a lack of the knowledge how a water vessel is trimmed to optimum in respect of economy.

There is a lot of patents in the area. Most of the suggested solutions are of a very complex art.

For example Bucklet U.S. Pat. No. 6,273,771 who teach us of a electronic CAN databus system for controlling all electronic units which can be found in a boat including navigating systems. It tells us about “stern drive actuator” but not how. The total cost of installation of this and the complexity is far away from the invention described in this document.

### SUMMARY OF THE INVENTION

The object of the present invention is to create an arrangement that takes care of the adjustments of the vessels movement in the water to create an optimum of low fuel consumption.

The invention consists of a central unit box with hardware and software which receives inputs from sensors and controls the trimming bodies to obtain comfortable performance and economy of the vessel.

The invention is very simple to install and can easily be done on every vessel. In a normal case the central unit is mounted somewhere and into its connection terminal board all existing sensors and trimming bodies are connected. The control unit is mounted close to other engine controls.

The most important parameter is the engines rpm. This parameter is close correlated to the speed of the vessel and the central unit makes calculations and central unit gives trimming commands to the trimming bodies. The sensors reads the actual situation and the servo loop works to give the correct movement.

The trimming of the propulsion unit and the trimming tabs are performed of the central units program according to settings which can differ from vessel to vessel. Together with the input from the rpm sensor and above mentioned settings it controls the behaviour of the trimming units.

The trimming of the stern propulsion and the trimming of trim tabs is controlled of the central unit and the electronic controls, the servos (air, oil, electric) which control the mechanical movements of the trimming bodies.

Sensors gives signals from the respective trimmed unit to the central unit and as in a common servo loop it will adjust according to the parameters. Tests and manual settings of data for different vessels are possible to do, they can change the behaviour of the vessel according to the input to the software.

Trimming of stern propulsion and trim tabs are done separate from each other in the first step. There is a possibility to add gyro and similar units for stabilisation. This trimming is done first, after that the other trimmings are done. At yawing the gyro function is automatically disconnected.

Disconnection can be done manually at any time.

The invention will be further described with the help of the following figures.

### BRIEF DESCRIPTION OF THE DRAWINGS

FIG. 1 shows a vessel;

FIG. 2 shows the central units connection;

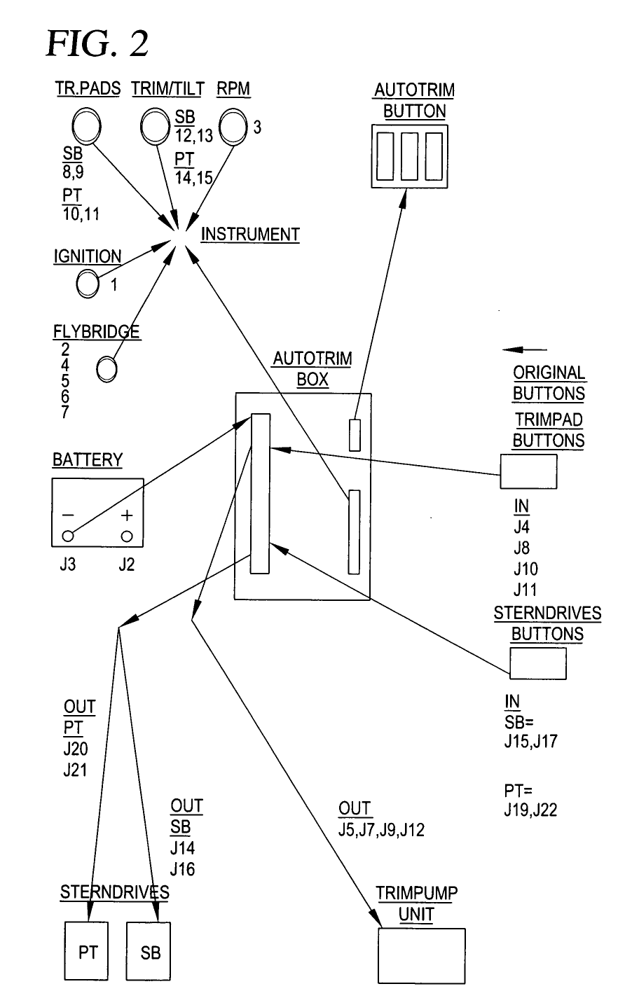

FIG. 3 shows the control unit;

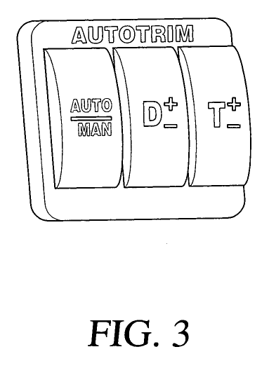

FIG. 4 shows the stern, trim tabs and adjusting unit; and

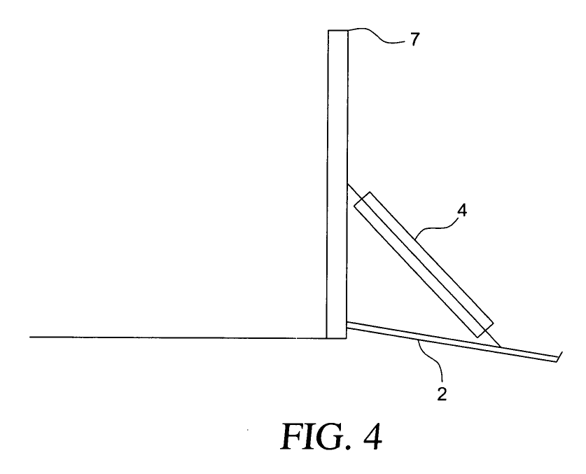

FIG. 5 shows the stern, propulsion and adjusting unit.

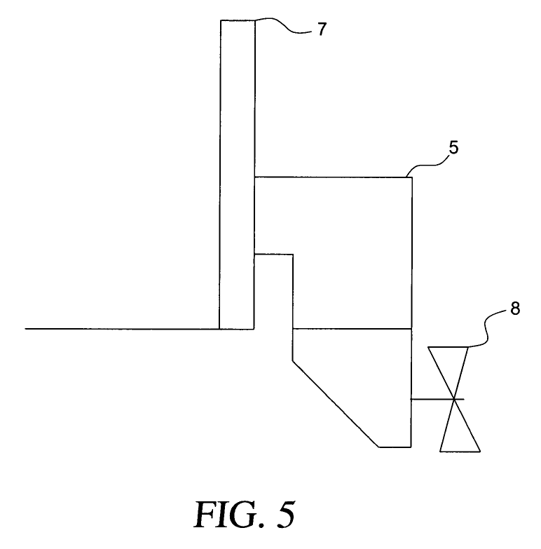

### DETAILED DESCRIPTION OF A PREFERRED EMBODIMENT

The system and the method in a simple setup is when trimtabs is automatically adjusted according to a program in the central unit and the input parameter is the rpm which controls the adjustments.

When the vessel is not moving, the program parameters of lowest and highest movement is set. The same for the propulsion units. At one or more high speed the regulation reference values are set.

In the simplest performance there is a linear function between rpm and the trimming bodies movements between mentioned references.

The propulsion unit is trimmed after the trimtabs are adjusted and the propulsion unit is trimmed in that the propulsion angel is parallel with the surface of the water. Experience has shown that this is optimum.

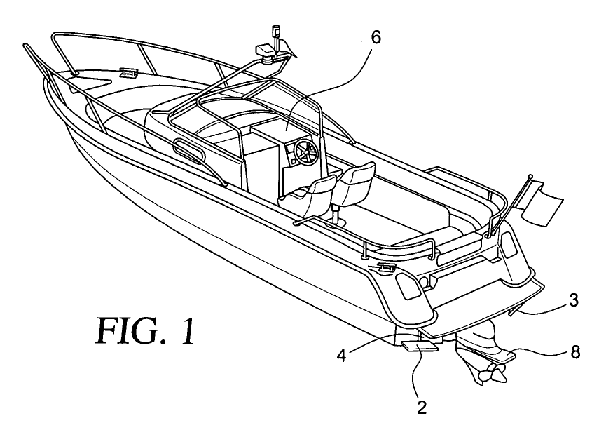

The FIG. 1 shows a vessel (1) which has two trimtabs (2) and (3) which is pivoted in the stern (7) for movements which shows in FIG. (4).

The trimtabs movements can be controlled from electrical engines, hydraulic, or other similar.

Two trimtabs (2) and (3) are shown in FIG. 1 but there may be others.

The propulsion unit (8) can be pivoted about a substantially vertical axis and, likewise, about a substantially horizontally axis. The adjustments are done on similar way as with trimtabs (2,3).

Both trimtabs (2,3) and the propulsion unit (8) has sensors for the angel or similarly which is connected to the central units connection board.

The engines rpm or similar is read and the value is transferred to the central unit. This mentioned signal is the input which more or less controls the trimming bodies movements, but adjustments can be done after different types of vessel, the weight depending of wind or other circumstances.

What is claimed is:

1. A water vessel with stern propulsion such as propeller drive or jet drive, or similar stern propulsion drive and preferably provided with one or more movable trimming bodies such as trimtabs in order to reduce the water resistance and adjust as well speed capacities as fuel economy
characterized in that this trimming is done with help of a unit called the central unit which unit consist of hardware and software, and said unit is connected into the vessels existing system and where some adjustments/settings are done according to the type of vessel and when these settings are done and saved in the central unit, the central units take care of the trimming of all trimming bodies in the system and the water resistance force is minimized to obtain low fuel consumption, the rpm of the engine being the sole dynamic input parameter for the central unit to compute the trimming bodies settings.

2. A water vessel with trimming bodies according to claim 1 above characterized in that the trimming tabs are one or more and the size can be different and the movements are controlled from the central unit.

3. A water vessel with trimming bodies according to claim 1, characterized in that the propulsion unit can be one or more, and the movements in different directions are controlled from the central unit.

4. A water vessel with trimming bodies according to claim 1, characterized in that the central unit can be mounted in optional old or new vessels and by connecting the vessels units for sensors and adjustments units for trimming bodies to the connection board and depending on tests from the software in the central unit, the unit detects what type of sensors the vessel is equipped with and that also includes a failure detection mode which can be seen by signal lamps on the control panel.

5. A water vessel with trimming bodies according to claim 1. characterized in that to the program in the central unit new settings can be made so the behaviours of the main program can be adjusted, if tests or other experience gives motivation for the changes, some reason for this could be different loads, waterskiing or other circumstances.

6. A water vessel with trimming bodies according to claim 1, characterized in that stabilization with help of a gyro can be included for correction in sidewise and this is acting on the trimtabs.

7. A water vessel with trimming bodies according to claim 1, characterized in that the stabilisation from gyro is not used at manual changing of the course.

8. A water vessel with trimming bodies according to claim 1, characterized in that the driver has an option that at any time disconnect all automatic controls and from that time take control of all mentioned units.

9. A water vessel with trimming bodies according to claim 1, characterized in that if the propulsion unit is manually put to the highest trim value the central unit detects the different end position of both the propulsion unit and the trimtabs.
